(19) United States
(12) Patent Application Publication
(10) Pub. No.: US 2025/0201836 A1
(43) Pub. Date: Jun. 19, 2025

(54) POSITIVE ELECTRODE ACTIVE MATERIAL, LITHIUM ION SECONDARY BATTERY, AND METHOD OF PRODUCING POSITIVE ELECTRODE ACTIVE MATERIAL

(71) Applicant: TOYOTA JIDOSHA KABUSHIKI KAISHA, Toyota-shi (JP)

(72) Inventors: Takahiko NINOMIYA, Miyoshi-shi (JP); Hiroo NOZAKI, Chiryu-shi (JP); Ryosuke OHSAWA, Okasaki-shi (JP); Taku KINOSHITA, Toyota-shi (JP)

(73) Assignee: TOYOTA JIDOSHA KABUSHIKI KAISHA, Toyota-shi (JP)

(21) Appl. No.: 18/828,257

(22) Filed: Sep. 9, 2024

(30) Foreign Application Priority Data
Dec. 15, 2023 (JP) 2023-212417

(51) Int. Cl. H01M 4/525; C01G 53/00; H01M 4/02; H01M 10/0525

(52) U.S. Cl. CPC H01M 4/525; C01G 53/44; H01M 10/0525; C01P 2002/22; C01P 2002/52; C01P 2002/72; C01P 2006/40; H01M 2004/028

(57) ABSTRACT

The disclosure relates to a positive electrode active material. The positive electrode active material having a crystalline structure in which a transition metal layer containing nickel and a lithium layer are alternately arranged, wherein an a/b axial length ratio calculated by Rietveld analysis of a radiation XRD is 0.8 or more.

### CROSS-REFERENCE TO RELATED APPLICATION

This application claims priority to Japanese Patent Application No. 2023-212417 filed on Dec. 15, 2023, incorporated herein by reference in its entirety.

### BACKGROUND

### 1. Technical Field

The present disclosure relates to a positive electrode active material, a lithium ion secondary battery, and a method of producing a positive electrode active material.

### 2. Description of Related Art

A lithium transition metal composite oxide having a layered crystal structure in which a transition metal layer formed of an octahedral structure composed of a transition metal and oxygen and a lithium layer are alternately arranged is widely used as a positive electrode active material for a lithium ion secondary battery.

As the lithium transition metal composite oxide having a layered crystal structure, one containing at least one kind selected from nickel, cobalt and manganese as a transition metal is known (see Japanese Unexamined Patent Application Publication No. 2019-23149 (JP 2019-23149 A), for example).

### SUMMARY

Among lithium transition metal composite oxides having a layered crystal structure, those containing nickel as a transition metal are suitable as positive electrode active materials for large-capacity lithium ion secondary batteries such as batteries for battery electric vehicles. On the other hand, lithium ion secondary batteries in which a positive electrode active material containing nickel as a transition metal is used involve an object of improving a capacity retention rate.

An object of the present disclosure is to provide a positive electrode active material containing nickel as a transition metal and providing a lithium ion secondary battery with an excellent capacity retention rate, a lithium ion secondary battery including a positive electrode containing the positive electrode active material, and a method of producing the positive electrode active material.

The means for addressing the above object includes the following aspects.

1

A positive electrode active material including
a crystal structure in which a transition metal layer containing nickel and a lithium layer are alternately arranged, in which an a/b axial length ratio calculated through a Rietveld analysis of radiation X-ray diffraction (XRD) is 0.8 or more.
   2

The positive electrode active material according to 1, including
a doping element having an ionic radius greater than that of nickel.
   3

The positive electrode active material according to 1 or 2, in which
the a/b axial length ratio is 1.2 or less.
   4

A lithium ion secondary battery including
a positive electrode including the positive electrode active material according to any one of 1 to 3.
   5

A method of producing a positive electrode active material having a crystal structure in which a transition metal layer containing nickel and a lithium layer are alternately arranged, including
adding a doping element to the positive electrode active material such that an a/b axial length ratio calculated through a Rietveld analysis of radiation X-ray diffraction (XRD) of the positive electrode active material is 0.8 or more.

According to an embodiment of the present disclosure, there are provided a positive electrode active material containing nickel as a transition metal and providing a lithium ion secondary battery with an excellent capacity retention rate, a lithium ion secondary battery including a positive electrode containing the positive electrode active material, and a method of producing the positive electrode active material.

### DETAILED DESCRIPTION OF EMBODIMENTS

In the present disclosure, numerical ranges specified herein with “A-B,” “between A and B,” “(from) A to B,” etc., represent ranges, which include the minimum A and the maximum B.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.

In the present disclosure, the term “step” is included in the term as long as the intended purpose of the step is achieved, even if it is not clearly distinguishable from other steps as well as independent steps.

In the present disclosure, a combination of two or more preferred embodiments is a more preferred embodiment.

In the present disclosure, the amount of each component means the total amount of a plurality of substances unless otherwise specified, when a plurality of substances corresponding to each component are present.

### Positive Electrode Active Material

The positive electrode active material of the present disclosure includes:
A transition metal layer comprising nickel and a lithium layer having an alternating crystal structure;
a/b axial length ratio calculated from the Rietveld analysis of the radiation XRD is 0.8 or more.

The positive electrode active material of the present disclosure is a compound belonging to a lithium transition metal complex oxide having a crystal structure (also referred to as a layered laminated structure or a R-3m type crystal structure) in which a transition metal layer having an octahedral structure and a lithium layer are alternately arranged. The octahedral structure is composed of a transition metal and oxygen.

In the present disclosure, the lithium transition metal composite oxide means a composite oxide including lithium and one or more transition metals.
a/b axial length ratio is a value obtained by dividing the length of the a-axis by the length of the b-axis in the crystalline structure of the positive electrode active material.

As shown in the embodiments to be described later, the lithium ion secondary battery using the positive electrode active material a/b axial length ratio is 0.8 or more, a/b axial length ratio shows an excellent capacity retention ratio as compared to the lithium ion secondary battery using the positive electrode active material is less than 0.8. The reason for this is inferred as follows, for example. However, the present disclosure is not limited by the following inference. a/b axial length ratio is calculated by Rietveld analysis of the radiation XRD.

It is known that in a lithium transition metal composite oxide having a layered crystal structure, a phenomenon called cation mixing in which transition metal ions occupy lithium sites of a lithium layer occurs. In addition, when nickel having a close ionic radius to lithium is included as the transition metal, cation mixing is likely to occur. Cation mixing may inhibit the migration of lithium ions during charging and discharging of a lithium ion secondary battery, and may cause a capacity retention rate.

The disclosed positive electrode active material has an a/b axial length ratio of 0.8 or more, which is calculated from Rietveld analysis of the radiation XRD. When a/b axial length ratio is 0.8 or more, the area of the triangle facing the lithium layer in the octahedral structure of the transition metal layer is reduced, and the migration of nickel ions from the transition metal layer to the lithium layer is less likely to occur. As a result, it is considered that the migration of nickel ions to the lithium layer is suppressed and the capacity retention ratio is improved.

From the viewpoint of improving the capacity retention ratio of the lithium ion secondary battery, a/b axial length ratio of the positive electrode active material is preferably 0.85 or more, more preferably 0.90 or more, and still more preferably 0.95 or more.
The upper limit of a/b axial length ratio of the positive electrode active material is not particularly limited, but is preferably 1.2 or less, more preferably 1.15 or less, and still more preferably 1.1 or less from the viewpoint of balancing the properties of the positive electrode active material.

a/b axial length ratio of the positive electrode active material is calculated by Rietveld analysis of the radiation XRD (X-ray diffractometry). The calculation of a/b axial length ratio can be carried out in a known manner. For example, it is carried out in the manner described in the examples which follow.

The positive electrode active material having an a/b axial length ratio of 0.8 or more can be obtained, for example, by adding a doping element to a raw material of the positive electrode active material. When a part of the transition metal constituting the transition metal layer of the positive electrode active material layer is replaced with the doping element, the area of the triangle facing the lithium layer of the transition metal ion (in particular, nickel ion) is reduced under the influence of the doping element. As a result, 10 it is considered that migration of transition metal ions (particularly nickel ions) to the lithium layer is suppressed, and the capacity retention rate of the lithium ion secondary battery is improved.

The type of the doping element included in the transition metal layer is not particularly limited, and examples thereof include Au, Bi, Hf, La, Mo, Nb, Pd, Pr, Rh, Pt, Sr, Ta, Tc, Ti, W, Y, Zr, and the like.

From the viewpoint of adjusting a/b axial length ratio to 0.8 or more, the positive electrode active material preferably contains a doping element having an ionic radius larger than nickel (ionic radius: 0.56 Å).

Preferred examples of the doping element having an ion radius larger than nickel (ion radius: 0.56 Å) include Y (ion radius: 0.69 Å), La (ion radius: 1.03 Å), Nb (ion radius: 0.72 Å), and W (ion radius: 0.62 Å). Preferable examples of the doping element having an ion radius larger than nickel (ion radius: 0.56 Å) include Sr (ion radius: 1.18 Å) and Pr (ion radius: 0.99 Å).

From the viewpoint of adjusting a/b axial length ratio of the positive electrode active material to 0.8 or more, the ionic radius of the doping element is more preferably 0.6 Å or more, still more preferably 0.7 Å or more, and still more preferably 0.8 Å or more.

The ion radius of the doping element contained in the positive electrode active material may be 2.0 Å or less, 1.5 Å or less, or 1.3 Å or less.

The kind of the doping element contained in the positive electrode active material may be one kind or two or more kinds.

The content of the doping element contained in the positive electrode active material is not particularly limited.
From the viewpoint of sufficiently obtaining a/b axial length ratio of the positive electrode active material to 0.8 or more, the content of the doping element may be 0.005 mol % or more with respect to the sum of the transition metal and the doping element contained in the positive electrode active material.
From the viewpoint of balance of characteristics of the positive electrode active material, the content of the doping element may be 1 mol % or less, 0.1 mol % or less, or 0.05 mol % or less with respect to the total of the transition metal and the doping element contained in the positive electrode active material.

The positive electrode active material of the present disclosure includes at least nickel as a transition metal.
From the viewpoint of balance of characteristics of the positive electrode active material, it is more preferable that the positive electrode active material contains nickel as a transition metal and at least one selected from cobalt and manganese. In addition, from the viewpoint of balancing the properties of the positive electrode active material, it is more preferable that the positive electrode active material contains nickel, cobalt, and manganese as transition metals (NCM, nickel cobalt manganese oxide).

NCM may contain a high proportion of Ni (e.g., 50 mol % or more, 60 mol % or more, or 70 mol % or more of the total transition metal).

The molar ratio of Ni, Co and Mn contained in NCM may be selected, for example, from the molar ratio (Ni:Co) of Ni to Co in the range of 1:0.1 to 1:1, and the molar ratio (Ni:Mn) of Ni to Mn in the range of 1:0.1 to 1:1.

The molar ratio (Ni:Co) of Ni to Co may be selected from 1:0.1 to 1:0.5, 1:0.1 to 1:0.3, or 1:0.1 to 1:0.2.
The molar ratio (Ni:Mn) of Ni to Mn may be selected from 1:0.1 to 1:0.5, 1:0.1 to 1:0.3, or 1:0.1 to 1:0.2.

The positive electrode active material may be in particulate form. The volume average particle diameter of the positive electrode active material in a particulate form is not particularly limited, and can be selected from, for example, a range of 5 μm to 30 μm. When the positive electrode active material is a secondary particle that is an aggregate of a plurality of primary particles, the volume average particle diameter is the volume average particle diameter of the secondary particles.
The volume average particle diameter of the positive electrode active material particles is not particularly limited, and can be selected, for example, from the range of 5 μm to 30 μm.

The volume-average particle size of the particles is the particle size (D50) when the cumulative volume is 50% in the volume-based particle size distribution. The volume-based particle size distribution is obtained, for example, by a laser diffraction and scattering method.

### Lithium Ion Secondary Battery

The lithium ion secondary battery of the present disclosure includes a positive electrode including the above-described positive electrode active material. The positive electrode includes, for example, a current collector and a positive electrode layer disposed on the current collector, and the positive electrode layer includes the positive electrode active material of the present disclosure.
The positive electrode layer may be disposed on one side or both sides of the current collector.

Examples of the material constituting the current collector of the positive electrode include aluminum, an aluminum alloy, nickel, titanium, and stainless steel. Examples of the shape of the current collector include a foil and a mesh.

The positive electrode layer is disposed on the current collector by, for example, applying a slurry-like positive electrode material to one or both surfaces of the current collector. If necessary, a pressure treatment for adjusting the density of the positive electrode layer may be performed. The thickness of the positive electrode layer is not particularly limited, and can be selected from, for example, a range of 10 μm to 100 μm.

The positive electrode material may be in a state of a mixture containing components other than the positive electrode active material, such as a conductive aid and a binder. If desired, a solvent may be added to the mixture to adjust the viscosity of the mixture.

Specific examples of the conductive aid include carbon materials such as
carbon black (acetylene black, thermal black, furnace black, and the like), carbon nanotubes, and graphite.
The conductive material contained in the positive electrode material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, and polyethylene oxide. Specific examples of the binder include polyepichlorohydrin, polyacrylonitrile, styrene-butadiene rubber (SBR), acrylonitrile-butadiene rubber (NBR), polyacrylates, and polymethacrylates.
The binder contained in the positive electrode material may be one kind alone or two or more kinds thereof.

The lithium ion secondary battery of the present disclosure includes, for example, a positive electrode, a negative electrode, and an electrolyte.
The negative electrode includes, for example, a current collector and a negative electrode layer disposed on the current collector and including a negative electrode active material.
Examples of the negative electrode active material include carbon materials, such as graphite, hard carbon, soft carbon, and activated carbon, silicon, metallic lithium, lithium alloy, and lithium titanate (LTO).
Examples of the material constituting the current collector of the negative electrode include copper, a copper alloy, nickel, titanium, and stainless steel. Examples of the shape of the current collector of the negative electrode include a foil and a mesh.

The electrolyte may be either a liquid or a solid. As the liquid electrolyte (electrolyte solution), a solution obtained by dissolving a known electrolyte such as LiPF₆ in an organic solvent can be used without any particular limitation.
Specific examples of the organic solvents include cyclic or linear carbonates such as ethylene carbonate (EC), dimethyl carbonate (DMC), diethyl carbonate (DEC), and ethyl methyl carbonate (EMC). The solvent may be a mixture of two or more solvents or a mixture comprising a cyclic carbonate and a linear carbonate.
Solvents may include additives such as vinylene carbonate (VC).
As the solid electrolyte, a known solid electrolyte such as a sulfide solid electrolyte, an oxide solid electrolyte, or a halide solid electrolyte can be used without any particular limitation.

The lithium ion secondary battery may include a separator disposed between the positive electrode and the negative electrode. Examples of the separator include a nonwoven fabric, a cloth, and a microporous film containing a polyolefin as a main component, such as polyethylene and polypropylene.

### Method for Producing a Positive Electrode Active Material

A method for producing a positive electrode active material according to the present disclosure includes:
A method for producing a positive electrode active material having a crystal structure in which a transition metal layer containing nickel and a lithium layer are alternately arranged, The method includes adding a doping element to the positive electrode active material such that an a/b axial length ratio calculated from a Rietveld analysis of a radiation XRD of the positive electrode active material is 0.8 or more.

In the present embodiment, a doping element is added to the positive electrode active material so that a/b axial length ratio calculated from the Rietveld analysis of the radiation XRD of the positive electrode active material is 0.8 or more. That is, a/b axial length ratio of the positive electrode active material produced by the disclosed process is 0.8 or more.
As shown in the embodiments to be described later, the lithium ion secondary battery using the positive electrode active material a/b axial length ratio is 0.8 or more, a/b axial length ratio shows an excellent capacity retention ratio as compared to the lithium ion secondary battery using the positive electrode active material is less than 0.8. a/b axial length ratio is calculated by Rietveld analysis of the radiation XRD.

Conditions for carrying out the disclosed methods are not particularly limited except that a doping element is added to the positive electrode active material so that a/b axial length ratio is 0.8 or more, and may be a known condition.
The method of the present disclosure may be, for example, a method including a step of calcining a mixture including a compound including a transition metal as a raw material of a positive electrode active material, a compound including lithium, and a compound including a doping element.
Examples of the compound containing a transition metal, lithium, or a doping element include hydroxides, carbonates, and oxides. The compound containing a transition metal may be a composite compound containing two or more transition metals.

The temperature at which the firing step is performed is not particularly limited, and can be selected from known firing conditions. The temperature of the firing may be selected, for example, from the range of 600° C. to 850° C.
The temperature at which the firing step is performed may be constant or varied from the start to the end of the firing step.
The calcination step can be performed, for example, in an atmosphere having an oxygen content of 40 vol % to 100 vol %.
The temperature or oxygen content during the firing step may be constant or varied from the start to the end of the firing step.
The firing process may be performed in one stage or may be performed in two or more stages.

The positive electrode active material produced by the method of the present disclosure may be the positive electrode active material of the present disclosure described above. That is, details and preferred aspects of the positive electrode active material produced by the method of the present disclosure may be the same as details and preferred aspects of the positive electrode active material of the present disclosure described above.

Hereinafter, the present disclosure will be described in more detail with reference to Examples, but the disclosure of the present disclosure is not limited to these Examples.

### Preparation of Positive Electrode Active Material

NiSO₄, CoSO₄ and MnSO₄ were dissolved in ion-exchanged water to obtain a raw material solution having a density of 30 mass %. The molar ratios of Ni, Co and Mn in the raw material dissolving solution were as shown in Table 1.

An aqueous solution of NH₃ was charged into the reactor, and nitrogen-substituted with stirring. NaOH was then added to the reactor to make the aqueous solution alkaline.
The raw material solution and NH₃ were added dropwise to precipitate Ni, Co and Mn hydroxides while controlling pH in the reactor to be constant. The resulting precipitate was removed by filtration and dispersed in ion-exchanged water. The precipitate dispersed in the ion-exchanged water was filtered and dried at 120° C. for 16 hours to remove moisture, thereby obtaining a transition metal hydroxide as a precursor of the positive electrode active material.

Lithium hydroxide and a compound containing a doping element shown in Table 1 were added to the obtained precursor and mixed to obtain a raw material of the positive electrode active material.
The amount of lithium hydroxide was adjusted so that the amount of lithium relative to the total of 1 mole of transition metals (Ni, Co, and Mn) in the precursor was 1 mole.
The amount of the compound containing the doping element was adjusted so that the amount of the doping element relative to the sum of the transition metals (Ni, Co and Mn) and the doping element in the precursors was 0.01 mol %.

The raw material of the positive electrode active material was fired at 600° C. for 4 hours in an atmosphere having an oxygen content of 40% by volume. Thereafter, the obtained calcined product was crushed, and further calcination was performed in an atmosphere having an oxygen content of 100% by volume at 700° C. for 10 hours. Through the above steps, a positive electrode active material was obtained.

### Evaluation of Battery Capacity Retention Rate

A positive electrode active material (88 parts by mass), acetylene black (10 parts by mass) as a conductive material, and polyvinylidene fluoride (2 parts by mass) as a binder were mixed, and the viscosity was adjusted with a solvent to obtain a positive electrode mixture. The positive electrode mixture was coated on an aluminum foil and dried at 80° C. for 5 minutes to obtain a positive electrode.
A laminate type evaluation battery was produced using the obtained positive electrode, separator (polyethylene microporous film), and an electrode body formed by laminating negative electrodes containing graphite as an active material in this order, and an electrolytic solution.
As the electrolyte solution, a mixed solvent of ethylene carbonate (EC), dimethyl carbonate (DMC), and ethyl methyl carbonate (EMC) in which LiPF₆ (concentration: 1 M) was dissolved (the volume ratio of EC/DMC/EMC was 3/4/3) was used.
The discharge capacity of CCCV charge (1.5 to 4.1 V) was measured with 0.1 C current to obtain the initial capacity. Then, 100 cycles of charging and discharging were performed at a 1 C of 1.5 to 4.1 V, and the discharge capacity after 100 cycles was measured. The capacity retention rate of the battery was determined by the following formula. The results are shown in Table 1.

$$Capacity retention ratio ( \% ) = ( discharge capacity after 100 cycles / initial capacity ) \times 100.$$

$$Calculation of a / b axial length ratio$$

a/b axial length ratio of the positive electrode active material was calculated by performing a Rietveld analysis of the radiation XRD.
Data of synchrotron radiation XRD was obtained using a SmartLab manufactured by Rigaku Corporation, and the measured angle (20) was 10° to 120°.
An analytical soft nano-lab was used to construct a R-3m type crystalline structure doped with doping elements. a/b axial length ratio was calculated by measuring the axial lengths of the crystalline axes a and b, which were changed by the change of the position of oxygen in the condition where Ni formed octahedra. The results are shown in Table 1.

### Calculation of Ni Mixing Quantity

The amounts of Ni ions transferred to the lithium layer (Ni mixing) in the batteries after 100 cycles of charging and discharging were calculated by Rietveld analysis of the radiation XRD under the above-described conditions. Specifically, Ni mixing rate (%) was calculated from the fitting of the diffractive pattern performed using the analysis soft Fullprof. The results are shown in Table 1.

TABLE 1

| | | | | Doping element | | | a/b | | |
|---|---|---|---|---|---|---|---|---|---|
| | | | | | | Ion | axial | Ni | Capacity |
| | Ratio (mol) | | | | | radius | length | mixing | maintaining |
| | Ni | Co | Mn | Type | (mol %) | (Å) | ratio | (%) | rate (%) |
| Comparative Example 1 | 0.8 | 0.1 | 0.1 | Fe | 0.01 | 0.55 | 0.78 | 8.2 | 72 |
| Example 1 | 0.8 | 0.1 | 0.1 | Y | 0.01 | 0.90 | 1.03 | 3.3 | 83 |
| Example 2 | 0.8 | 0.1 | 0.1 | La | 0.01 | 1.03 | 1.07 | 3.1 | 82 |
| Example 3 | 0.8 | 0.1 | 0.1 | Nb | 0.01 | 0.72 | 0.94 | 3.4 | 86 |
| Example 4 | 0.8 | 0.1 | 0.1 | W | 0.01 | 0.62 | 0.91 | 3.5 | 85 |
| Example 5 | 0.8 | 0.1 | 0.1 | Sr | 0.01 | 1.18 | 1.09 | 3.6 | 81 |

As shown in Table 1, the batteries of Examples 1 to 5 prepared using a positive electrode active material having an a/b axial length ratio of 0.8 or more had better capacity retention after cycling test than the batteries of Comparative Example 1 prepared using a positive electrode active material having an a/b axial length ratio of less than 0.8. Further, as shown in Table 1, the batteries of Examples 1 to 5 have a smaller Ni mixing rate after the cycling test than the batteries of Comparative Example 1. The above results suggest that when a/b axial length ratio of the positive electrode active material is 0.8 or more, the mixing of Ni ions from the transition metal layer into the lithium layer is suppressed, and the capacity retention ratio of the battery is improved.

What is claimed is:

1. A positive electrode active material comprising a crystal structure in which a transition metal layer containing nickel and a lithium layer are alternately arranged, wherein an a/b axial length ratio calculated through a Rietveld analysis of radiation X-ray diffraction is 0.8 or more.

2. The positive electrode active material according to claim 1, wherein the positive electrode active material contains a doping element having an ionic radius greater than that of nickel.

3. The positive electrode active material according to claim 1, wherein the a/b axial length ratio is 1.2 or less.

4. A lithium ion secondary battery comprising a positive electrode comprising the positive electrode active material according to claim 1.

5. A method of producing a positive electrode active material having a crystal structure in which a transition metal layer containing nickel and a lithium layer are alternately arranged, the method comprising adding a doping element to the positive electrode active material such that an a/b axial length ratio calculated through a Rietveld analysis of radiation X-ray diffraction of the positive electrode active material is 0.8 or more.
